(19) United States
(12) Patent Application Publication
(10) Pub. No.: US 2009/0009465 A1
(43) Pub. Date: Jan. 8, 2009

(54) DRIVING APPARATUS FOR A DISPLAY DEVICE AND ELECTROPHORETIC DISPLAY DEVICE INCLUDING THE SAME

(75) Inventors: Uk-Chul CHOI, Cheonan-si (KR); Cheol-Woo PARK, Suwon-si (KR); Ho-Yong JUNG, Yongin-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/027,053

(22) Filed: Feb. 6, 2008

(30) Foreign Application Priority Data
Jul. 3, 2007 (KR) 10-2007-0066473

(51) Int. Cl. G09G 3/34; G09G 3/20

(52) U.S. Cl. 345/107; 345/84

(57) ABSTRACT

An apparatus for driving a display device including first and second signal lines connected to a plurality of pixels, third and fourth signal lines connected to a plurality of sensors, and a display area displaying images includes a data driver to apply a data signal to the first signal line, an image scan driver to apply an image scanning signal to the second signal line, a sensing scan driver to apply a sensing scanning signal to the third signal line, a sensing signal processor connected to the fourth signal line, a signal controller to control the data driver, the image scan driver, the sensing scan driver, and the sensing signal processor, and a memory to store information from the sensing signal processor. The information is displayed and erased on a portion of the display area.

### CROSS-REFERENCE TO RELATED APPLICATION

This application claims priority from and the benefit of Korean Patent Application No. 10-2007-0066473, filed on Jul. 3, 2007, which is hereby incorporated by reference for all purposes as if fully set forth herein.

### BACKGROUND OF THE INVENTION

1. Field of the Invention

The present invention relates to a driving apparatus for a display device and an electrophoretic display including the same.

2. Discussion of the Background

An electrophoretic display (EPD) is a type of flat panel display device that is often used for electronic books. An EPD includes two panels including field-generating electrodes and a plurality of micro-capsules interposed between the panels. Each micro-capsule may include electric ink containing a plurality of white and black pigment particles that are negatively and positively charged, respectively.

When a voltage is applied to the field-generating electrodes to generate a potential difference, the white and black electrophoretic particles move toward electrodes of opposite polarity, thereby displaying images.

EPD devices may have high reflectance and high contrast independent of the viewing direction. Thus, a screen of an EPD may be as comfortable to view as a sheet of paper. Since each micro-capsule is stable in both a black state and a white state, each micro-capsule may maintain a black state or a white state without maintaining a voltage across the electrodes. Accordingly, power consumption for the EPD may be reduced. In addition, an EPD device may be manufactured at a low cost since EPD devices do not require polarizers, alignment layers, liquid crystal, etc., which tend to be expensive requisites for liquid crystal display devices.

Recently, a display device including a touch sensing function has been developed. A display device having a touch sensing function may include a sensing scan driver and a sensing signal processor in addition to a display panel assembly, an image scan driver, and a data driver.

The image scan driver and the sensing scan driver may include a plurality of stages. The stages may be substantially shift registers arranged in a row. The stages may sequentially generate a scanning signal for a first stage by receiving and outputting a scanning start signal to the display panel assembly, while simultaneously transmitting a carry output to a next stage.

However, with an EPD it may be possible to select from a predetermined menu and read the information displayed on the screen, but not to write or erase information including symbols, such as characters and numbers.

### SUMMARY OF THE INVENTION

The present invention provides a driving apparatus that can write and erase information, and an EPD including the same.

Additional features of the invention will be set forth in the description which follows, and in part will be apparent from the description, or may be learned by practice of the invention.

The present invention discloses an apparatus for driving a display including first and second signal lines connected to a plurality of pixels, third and fourth signal lines connected to a plurality of sensors, and a display area to display images. The apparatus includes a data driver to apply a data signal to the first signal line, an image scan driver to apply an image scanning signal to the second signal line, a sensing scan driver to apply a sensing scanning signal to the third signal line, a sensing signal processor connected to the fourth signal line, a signal controller to control the data driver, the image scan driver, the sensing scan driver, and the sensing signal processor, and a memory to store information from the sensing signal processor. The information is displayed and erased on a portion of the display area.

The present invention also discloses an EPD including an electrophoretic display panel assembly, first and second signal lines connected to a plurality of pixels, third and fourth signal lines connected to a plurality of sensors, a data driver to apply a data signal to the first signal line, an image scan driver to apply an image scanning signal to the second signal line, a sensing scan driver to apply a sensing scanning signal to the third signal line, a sensing signal processor connected to the fourth signal line, and a display area to display images. Information from the sensing signal processor is displayed and erased on a portion of the display area.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a block diagram of an EPD according to an exemplary embodiment of the present invention.

FIG. 2 is an equivalent circuit of a pixel of the EPD according to an exemplary embodiment of the present invention.

FIG. 3 is a cross-sectional view of a display panel assembly for an EPD according to an exemplary embodiment of the present invention.

FIG. 4 is a block diagram of an image scan driver according to an exemplary embodiment of the present invention.

FIG. 5 is a circuit view of a shift register of an i^{th} stage for the image scan driver shown in FIG. 4.

FIG. 6 is a signal waveform showing the operation of the image scan driver shown in FIG. 5.

FIG. 7 is a view showing a display area of an EPD that includes a fixing display area and a changing display area according to an exemplary embodiment of the present invention.

FIG. 8 is a view showing an example of writing a character in the changing display area among the display area of the EPD according to an exemplary embodiment of the present invention.

FIG. 9 is a view showing the movement of the electrophoretic particles in the micro-capsule shown in FIG. 3.

FIG. 10 is a view showing an example of writing and erasing a character in the changing display area among the display area of the EPD according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

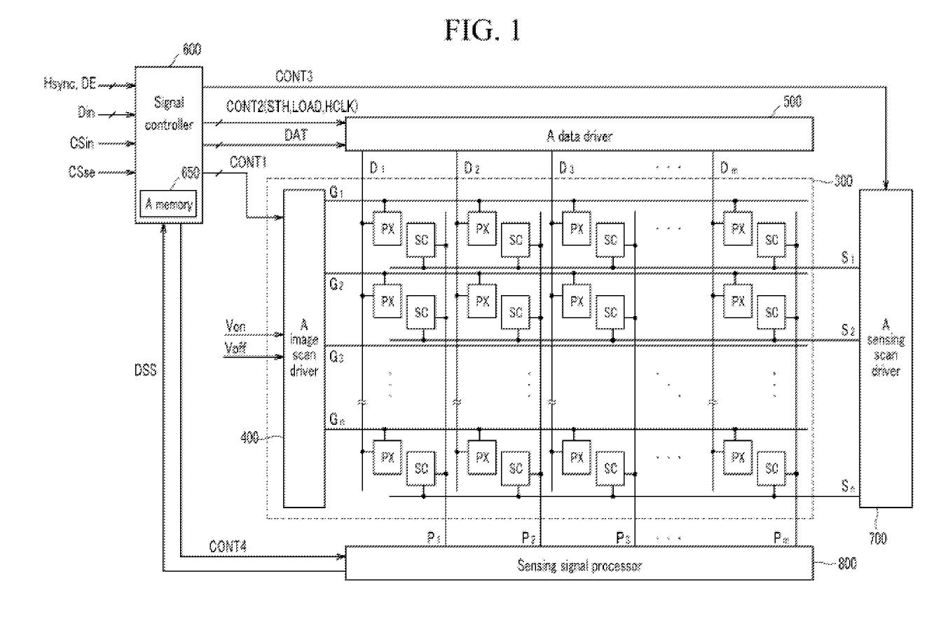

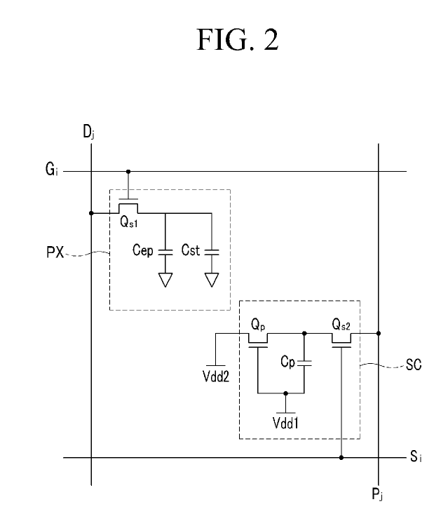

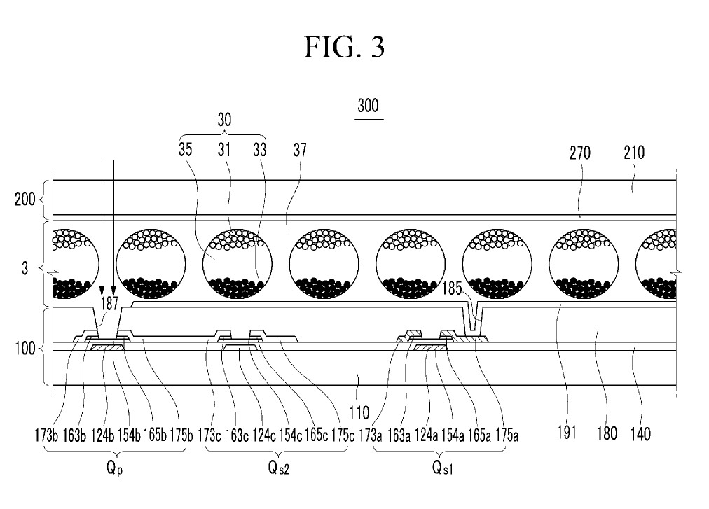

First, an EPD will be described with reference to FIG. 1, FIG. 2, and FIG. 3 as an example of a display device according to an exemplary embodiment of the present invention.

As shown in FIG. 1, the EPD according to an exemplary embodiment of the present invention includes an electrophoretic panel assembly 300, an image scan driver 400, a data driver 500, a signal controller 600, a sensing scan driver 800, and a sensing signal processor 900.

As shown in the equivalent circuit of FIG. 1 and FIG. 2, the electrophoretic display panel assembly 300 includes a plurality of display signal lines G1-Gn and D1-Dm, a plurality of sensing signal lines S1-Sn and P1-Pm, and a plurality of pixels PX and a plurality of sensors SC, which are arranged in a matrix form. Further, as shown in FIG. 3, the electrophoretic display panel assembly 300 includes lower and upper panels 100 and 200 facing each other and an electrophoretic layer 3 interposed between the lower and upper panels 100 and 200.

The display signal lines G1-Gn and D1-Dm are disposed on an insulation substrate 110, which may include transparent glass or plastic, of the lower panel 100, and include a plurality of image scanning lines G1-Gn to transfer an image scanning signal and a plurality of image data lines D1-Dm to transfer an image data signal. The image scanning lines G1-Gn extend in a row direction and are parallel to each other, and the image data lines D1-Dm extend in a column direction and are parallel to each other.

As shown in FIG. 2 and FIG. 3, each pixel PX, for example, a pixel PX connected to an i^{th} image scanning line Gi and a j^{th} image data line Dj, includes a switching element Qs1 connected to the display signal lines Gi and Dj, and an electrophoretic capacitor Cep and a storage capacitor Cst that are connected to the switching element Qs1, where i=1, 2, . . . , n and j=1, 2, . . . , m.

The switching element Qs1 is a three terminal element, such as a thin film transistor, disposed on the lower panel 100. The switching element Qs1 includes a control terminal 12a connected to an image scanning line Gi, an input terminal 173a connected to an image data line Dj, and an output terminal 175a connected to an electrophoretic capacitor Cep and a storage capacitor Cst. Also, the switching element Qs1 includes a semiconductor 154a disposed between the control terminal 12a and the input terminal 173a and between the control terminal 12a and the output terminal 175a, and ohmic contacts 163a and 165a disposed on the semiconductor 154a.

A pixel electrode 191 is connected to a switching element Qs1, and a common electrode 270 is disposed on a front surface of the upper panel 200 and receives a common voltage Vcom. The pixel electrode 191 may include a transparent conductor such as ITO or IZO or an opaque metal, and the common electrode 270 may include a transparent conductor. A passivation layer 180 is interposed between the pixel electrode 191 and the switching element Qs1. The pixel electrode 191 is connected to the output terminal 175a of the switching element Qs1 through a contact hole 185 of the passivation layer 180. The electrophetic capacitor (Cep) includes the pixel electrode 191 of the lower panel 100, the common electrode 270 of the upper panel 200, and the electrophetic layer 3.

The electrophoretic layer 3 includes a plurality of microcapsules 30 and a binder 37 to fix the microcapsules 30. Each microcapsule 30 includes a white electrophoretic particle 31 with a negative charge (−) or a positive charge (+), a black electrophoretic particle 33 with the opposite charge, and a transparent dielectric fluid 35.

A storage capacitor Cst functioning as an under part of the electrophoretic capacitor Cep is formed by the overlapping of an additional signal line (not shown) disposed on the lower display panel 100 with the pixel electrode 191 with an insulating material interposed therebetween. A predetermined voltage, such as a common voltage Vcom, is applied to the additional signal line. However, the storage capacitor Cst may be formed by the overlapping of the pixel electrode 191 with a previous image scanning line Gi-1 with an insulator as a medium. The storage capacitor Cst may be omitted according to need.

The sensing signal lines S1-Sn and P1-Pm are also disposed on the insulation substrate 110, and include a plurality of sensing scanning lines S1-Sn to transmit a scanning signal and a plurality of data lines P1-Pm to transmit a sensing data signal. The sensing scanning lines S1-Sn extend in a row direction and are parallel to each other, and the sensing data lines P1-Pm extend in a column direction and are parallel to each other.

Each sensor SC, for example a sensor SC connected to an i^{th} sensing scanning line Si and a j^{th} sensing data line Pj, includes a sensing element Qp, a switching element Qs2, and a sensing capacitor Cp, where i=1, 2, . . . , n and j=1, 2, . . . , m. The sensor SC is disposed on the lower panel 100 and is mostly covered by the passivation layer 180.

The sensing element Qp is a three terminal element such as a thin film transistor. The sensing element Qp includes a control terminal 124b connected to a sensing control voltage Vdd1, an output terminal 175b connected to one end of a capacitor Cp and an input terminal 173c of a switching element Qs2, and an input terminal 173b connected to a sensing input voltage Vdd2. The sensing element Qp includes a semiconductor 154b disposed between a control terminal 124b and an input terminal 173b and between a control terminal 124b and an output terminal 175b, and ohmic contacts 163b and 165b disposed on the semiconductor 154b. When light is radiated to the semiconductor 154b of the sensing element Qp through an exposure hole 187 formed on the passivation layer 180, an optical current is formed. The optical current flows to the sensing capacitor Cp and the switching element Qs2 due to a voltage difference between an input terminal 173b and an output terminal 175b.

The sensing capacitor Cp includes one end connected to a sensing control voltage Vdd1 and the other end connected to an output terminal 175b of a sensing element Qp and an input terminal 173c of a switching element Qs2. The sensing capacitor Cp accumulates a charge according to an optical current from the sensing element Qp to sustain a predetermined voltage.

Also, the switching element Qs2 is a three terminal element such as a thin film transistor. The switching element Qs2 includes a control terminal 124c connected to a sensing scanning line Si, an output terminal 175c connected to a sensing data line Pj, and an input terminal 173c connected to an output terminal of a sensing element Qp. The switching element Qs2 includes a semiconductor 154c disposed between a control terminal 124c and an input terminal 173c and between a control terminal 124c and an output terminal 175c, and ohmic contacts 163c and 165c disposed on the semiconductor 154c. The switching element Qs2 outputs a voltage stored in a sensing capacitor Cp or an optical current from a sensing element Qp to a sensing data line Pj as a sensing data signal when a sensing scanning signal is applied.

The semiconductors 154a, 154c, and 154b may include amorphous silicon or polysilicon. The control terminals 124a, 124b, and 124c and the semiconductors 154a, 154b, and 154c are insulated from each other by a gate insulating layer 140.

Although the pixels PX and the sensors SC were described to be identical in number, the number of sensors SC may be smaller than the number of pixels PX. Accordingly, the number of sensing scanning lines S1-Sn and sensing data lines P1-Pm may be controlled.

For example, if a resolution of a liquid crystal display is a quarter video graphic array (QVGA, 240*320 dots) and a resolution of a sensor SC is QVGA, one sensor SC may be disposed per every three pixels PX. If a resolution of a sensor SC is quarter QVGA (QQVGA, 120*160 dots), one sensor Sc may be disposed per 12 pixels PX. Herein, 1 dot denotes a unit having three pixels PX to display one image.

The image scan driver 400 includes a plurality of output terminals connected to the image scanning lines G1-Gn of the EPD panel assembly 300 to apply an image scanning signal to the image scanning lines G1-Gn through the output terminals. The image scanning signal includes a gate-on voltage Von and a gate-off voltage Voff to turn the switching element Qs1 on or off. The image scan driver 400 may be integrated on the electrophoretic display panel assembly 300 with signal lines G1-Gn and D1-Dm and switching elements Qs1 and Qs2. However, the image scan driver 400 may be directly disposed on the electrophoretic display panel assembly 300 in the form of at least one IC chip, may be attached on the electrophoretic display panel assembly 300 in the form of a tape carrier package TCP after being mounted on a flexible printed circuit film (not shown), or may be mounted on an additional printed circuit board PCB (not shown).

The data driver 500 is connected to the image data lines D1-Dm of the EPD panel assembly 300 and applies an image data signal to the data lines D1-Dm. The data driver 500 may be directly disposed on the EPD panel assembly 300 in the form of at least one IC chip, may be attached on the EPD panel assembly 300 in the form of a tape carrier package TCP after being mounted on a flexible printed circuit film (not shown), or may be mounted on an additional printed circuit board PCB (not shown). Alternatively, the image scan driver 400 and the data driver 500 may be integrated on the EPD panel assembly 300 with the signal lines G1-Gn and D1-Dm and switching elements Qs1 and Qs2.

The sensing scan driver 700 includes a plurality of output terminals connected to the sensing scanning line S1-Sn of the EPD panel assembly 300 to apply a sensing scanning signal to the sensing scanning lines S1-Sn through the output terminals. The sensing scanning signal includes a turn-on voltage and a turn-off voltage to turn the switching element Qs2 on or off. The sensing scan driver 700 may output the turn-on voltage through all output terminals and may output the turn-on voltage through only part of the output terminals. The scan driver 700 may be integrated on the electrophetic display panel assembly 300 along with the signal lines S1-Sn and P1-Pm, the switching elements Qs1 and Qs2, and the sensors SC. Alternatively, the sensing scan driver 700 may be directly disposed on the EPD panel assembly 300 in the form of at least one IC chip, may be attached on the EPD panel assembly 300 in the form of a tape carrier package TCP after being mounted on a flexible printed circuit film (not shown), or may be mounted on an additional printed circuit board PCB (not shown).

The sensing signal processor 800 is connected to sensing data lines P1-Pm of an EPD panel assembly 300 and receives a sensing data signal output through sensing data lines P1-Pm.

The signal controller 600 controls operations of the image scan driver 400, the data driver 500, the sensing scan driver 700, and the sensing signal processor 800. Particularly, the signal controller 600 determines the touch between the screen and another substance and confirms the position according to the signal from the sensing signal processor 800, then performs a display operation by controlling the image scan driver 400 and the data driver 500 according to the result.

Furthermore, the signal controller 600 includes a memory 650 and stores information from the sensing signal processor 800 in predetermined units. Alternatively, the memory 650 may be provided as a separate element.

Hereinafter, the display operation of an EPD device will be described in detail.

The signal controller 600 receives an input image signal Din from an external graphic controller, as well as an input image control signal CSin and an input sensing control signal CSse to control the display of the input image signal Din.

The input image signal Din includes luminance information of a pixel PX, which is input as a frame unit. For example, the input image control signal CSin may include a vertical synchronization signal, a horizontal synchronizing signal, a main clock signal, etc.

The signal controller 600 appropriately processes the input image signal Din, the input image control signal CSin, and the input sensing control signal CSse according to the operating condition of the display panel assembly 300, and generates an image scan control signal CONT1, an image data control signal CONT2, an output image signal DAT, a sensing scan control signal CONT3, and a processing control signal CONT4. Then, the signal controller 600 outputs the image scan control signal CONT1 to the image scan driver 400, outputs the image data control signal CONT2 and the output image signal DAT to the data driver 500, outputs the sensing scan control signal CONT3 to the sensing scan driver 700, and outputs the processing control signal CONT4 to the sensing signal processor 800.

The image scan control signal CONT1 includes a scanning start signal to initiate image scanning, at least one clock signal to control the output cycle of the gate-on voltage, and an output selection signal to control the output of the gate-on voltage in each output terminal of the image scan driver 400.

The image data control signal CONT2 includes a horizontal synchronization start signal STH to inform the data transmission of one pixel row, a load signal LOAD to apply a corresponding data voltage to image data lines D1-Dm, and a data clock signal HCLK.

The sensing scan control signal CONT3 includes a scanning start signal to initiate sensing scanning and at least one clock signal to control the output cycle of the turn-on voltage, and may further include an input selection signal to control the output of the turn-on voltage in the output terminal of the sensing scan driver 700.

The processing control signal CONT4 controls the operation of the sensing signal processor 800 to convert analog sensing data signals received from the sensing data lines P1-Pm into digital sensing data signals.

The image scan driver 400 outputs the image scanning signal to the image scanning lines G1-Gn through the output terminals according to the image scan control signal CONT1 of the signal controller 600. When the image scanning signal is a gate-on voltage, the switching element Qs1 connected to the image scanning lines G1-Gn is turned on, but when the image scanning signal is a gate-off voltage, the switching element Qs1 remains in an off state. The image scan driver 400 may apply the gate-on voltage according to the output selection signal to only part of the image scanning lines G1-Gn. In this case, the remaining image scanning lines G1-Gn may receive the image scanning signal or the gate-off voltage.

The data driver 500 receives an output image signal DAT according to the data control signal CONT2 from the signal controller 600, converts the output image signal DAT to a corresponding data voltage, and applies the converted voltage to the data lines D1-Dm.

The sensing scan driver 700 sequentially outputs the turn-on voltage to all of the output terminals according to the sensing scan control signal CONT3 from the signal controller 600.

Accordingly, the switching element Qs2 connected to the sensing scanning lines S1-Sn receives the turn-on voltage and is turned on, and the sensing data lines P1-Pm transmit the element output signal output from the sensor SC to the sensing signal processor 800 as a sensing data signal.

The sensing signal processor 800 converts the analog sensing data signal output through the sensing data lines P1-Pm according to the processing control signal CONT4 into a digital sensing data signal DSS and outputs it to the signal controller 600.

On the other hand, the data voltage applied to the data lines D1-Dm is applied to a corresponding pixel PX through the turned-on switching element Qs1, and the difference between a data voltage applied to a pixel PX and a common voltage Vcom is shown as a charging voltage of an electrophoretic capacitor Cep, that is, a pixel voltage. The electric field is generated in the electrophetic layer 3 in response to the pixel voltage such that the electrophoretic particles 31 and 33 move. The final locations of the electrophoretic particles 31 and 33 vary in the micro-capsule 30 according to the pixel voltage level, the polarity of the pixel voltage, and the time at which the pixel voltage is applied, and the luminance of the pixel PX is changed according to the location.

For example, if a white electrophoretic particle 31 is located closer to the common electrode 270, the EPD device displays a white color. To the contrary, if a black electrophoretic particle 33 is located closer to the common electrode 270, the EPD device displays a black color. If white and black color electrophoretic particles 31 and 33 are located in the middle of the micro-capsule 30, the EPD device displays a gray color. As described above, the EPD device displays various gray images by changing the locations of the electrophoretic particles 31 and 33 in the micro-capsule 30.

Here, if the data voltage is the same as the common voltage Vcom, that is to say, when the same voltage is applied or when a voltage is not applied, the electric field is not generated in the electrophoretic layer 3, so the electrophoretic particles 31 and 33 maintain their positions and the luminance of the pixel PX remains the same. By repeatedly performing this process during one horizontal period 1H (one period of a horizontal synchronizing signal Hsync and a data enable signal DE) as a unit, a gate-on voltage Von is sequentially applied to the desired image scanning lines G1-Gn, thereby changing the luminance of the desired pixels PX.

Further, a data voltage and an inversion voltage, which has polarity opposite that of the data voltage, are applied at an appropriate level at an appropriate time just before the application of the data voltage, thereby preventing the degradation of the display device due to charge incline, which may be generated when the direction of the electric field applied to the electrophoretic particles 31 and 33 is the same.

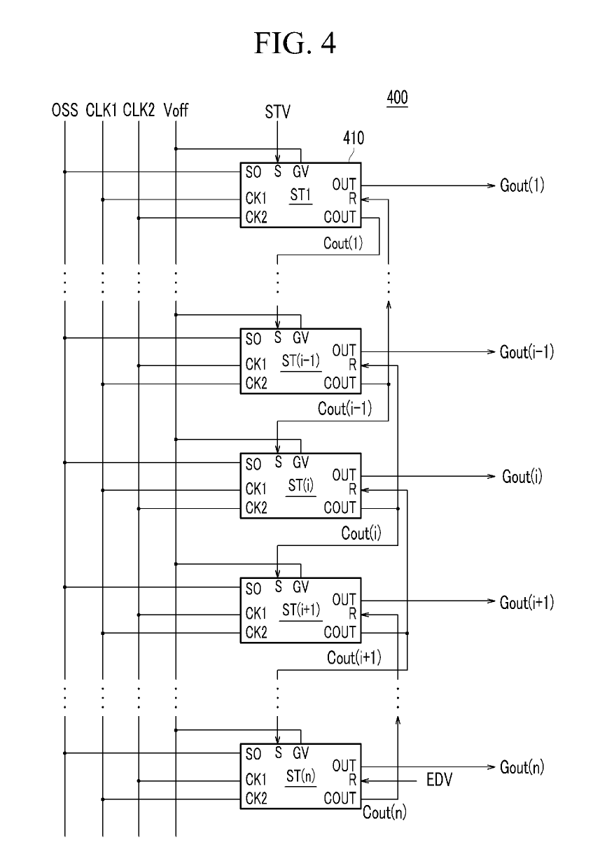

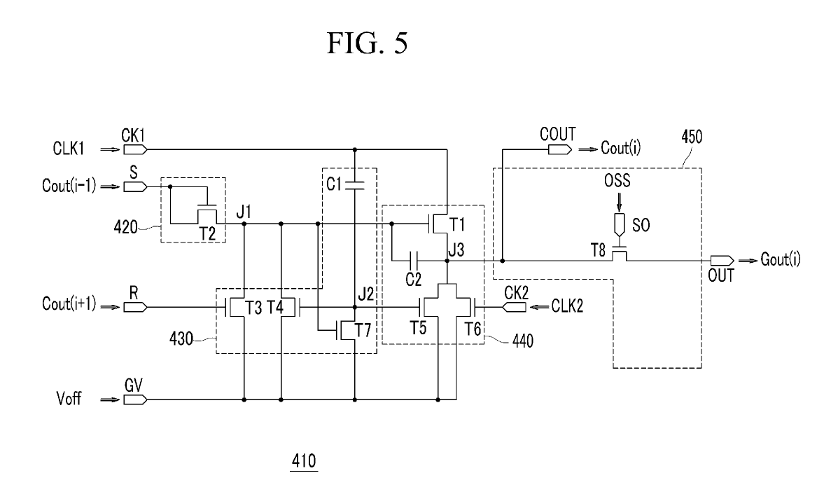

Hereinafter, an image scan driver for an EPD according to an exemplary embodiment of the present invention will be described with reference to FIG. 4, and FIG. 5.

As shown in FIG. 4, an image scan driver 400 is a shift register including a plurality of stages 410 connected to image scanning lines G1-Gn. The image scan driver 400 receives a scanning start signal STV, a scanning end signal EDV, a pair of clock signals CLK1 and CLK2, a gate-off voltage Voff, and an output selection signal OSS.

Each stage 410 includes a set terminal S, a reset terminal R, a gate voltage terminal GV, a pair of clock terminals CK1 and CK2, an output terminal OUT, a carry output terminal COUT, and a selection terminal SO.

In each stage 410, for example, an i^{th} stage [ST(i)], the set terminal S receives a carry signal [Cout(i−1)] of a previous stage [ST(i−1)], and the reset terminal R receives a carry signal [Cout(i−1)] of the next stage [ST(i+1)]. The gate voltage terminal GV receives the gate-off voltage Voff, the clock terminals CK1 and CK2 respectively receive clock signals CLK1 and CLK2 for odd stages and vice-versa for even stages, and the output selection terminal SO receives the output selection signal OSS. The output terminal OUT outputs the image scanning output [Gout(i)] to the image scanning line Gi, and the carry output terminal COUT outputs the carry signal [Cout(i)] to the previous stage [ST(i−1)] and the next stage [ST(i+1)]. Herein, the carry signal may be identical to the image scanning output [Gout(i)].

In other words, each stage 410 generates a preliminary output signal based on a carry signal [Cout(i−1)] of a previous stage [ST(i−1)] and a carry signal [Cout(i+1)] of the next stage [ST(i+1)], in synchronization with the clock signals CLK1 and CLK2. The generated preliminary output signal may be output as the carry signal [Cout(i)] through the carry output terminal COUT, or may be selectively output as the image scanning output [Gout(i)]. The output of the image scanning output [Gout(i)] may be determined according to the output selection signal OSS.

A scanning start signal STV is input to the set terminal S of the first stage ST1 instead of the carry signal of the previous stage, and a scanning end signal EDV is input to the reset terminal R of the last stage [ST(n)] instead of the carry signal of the next stage.

The clock signals CLK1 and CLK2 have a duty ratio of about 50% and a phase difference of about 180°. For example, if a clock signal CLK1 is input to a clock terminal CK1 and a clock signal CLK2 is input to a clock terminal CK2 in an i^{th} stage [ST(i)], a clock signal CLK2 is input to a clock terminal CK1 and a clock signal CLK1 is input to a clock terminal CK2 in the adjacent (i−1)^{th} and (i+1)th stages [ST(i−1) and ST(i+1)].

Referring to FIG. 5, each stage of the image scan driver 400 according to the present exemplary embodiment, for example, an i^{th} stage, includes a first input section 420, a second input section 430, a preliminary output generator 440, and an output determiner 450. Each constituent element includes at least one of N channel field effect transistors T1, T2, T3, T4, T5, T6, T7, and T8, which each may include amorphous silicon. Instead of the N channel field effect transistors, P channel field effect transistors can be used.

The first input section 420 includes a transistor T2 connected to a set terminal S. The transistor T2 includes an input terminal and a control terminal, which are commonly connected to the set terminal S, and operates as a diode. The transistor T2 outputs a gate-on voltage Von, which is a high voltage, to a junction J1.

The second input section 430 outputs a gate-off voltage Voff, which is a low voltage, to junctions J1 and J2, and includes three transistors T3, T4, and T7 and a capacitor C1. The transistor T3 has a control terminal connected to a reset terminal R and outputs a gate-off voltage Voff to the junction J1. The transistor T4 includes a control terminal connected to a junction J2 and outputs a gate-off voltage Voff to the junction J1. The transistor T7 includes a control terminal connected to a junction J1 and outputs a gate-off voltage Voff to the junction J2. The capacitor C1 is connected between a clock terminal CK1 and the junction J2.

The preliminary output signal generator 440 is connected between a first clock terminal CK1 and a gate-off voltage terminal GV, selectively outputs a first clock signal CLK1 and a gate-off voltage Voff to the junction J3 according to a voltage of the junctions J1 and J2, and includes three transistors T1, T5, and T6, and a capacitor C2. The transistor T1 includes a control terminal connected to the junction J1 and outputs a clock signal CLK1 to the junction J3. The transistor T5 includes a control terminal connected to the junction J2 and outputs a gate-off voltage Voff to the junction J3. The transistor T6 includes a control terminal connected to the clock terminal CK2 and outputs a gate-off voltage Voff to the junction J3. The capacitor C2 is connected between the junction J1 and the junction J3.

The output determiner 450 includes a transistor T8 connected between the output terminal OUT and the junction J3. The transistor T8 has a control terminal connected to the output selection terminal SO and transmits the voltage of the junction J3 to the output terminal OUT connected to the image scanning line G1-Gn.

The carry output terminal COUT is connected to the junction J3. The carry output terminal COUT transmits the voltage of the junction J3 to the reset terminal R of the previous stage [ST(i−1)] and the set terminal S of the next stage [ST(i+1)].

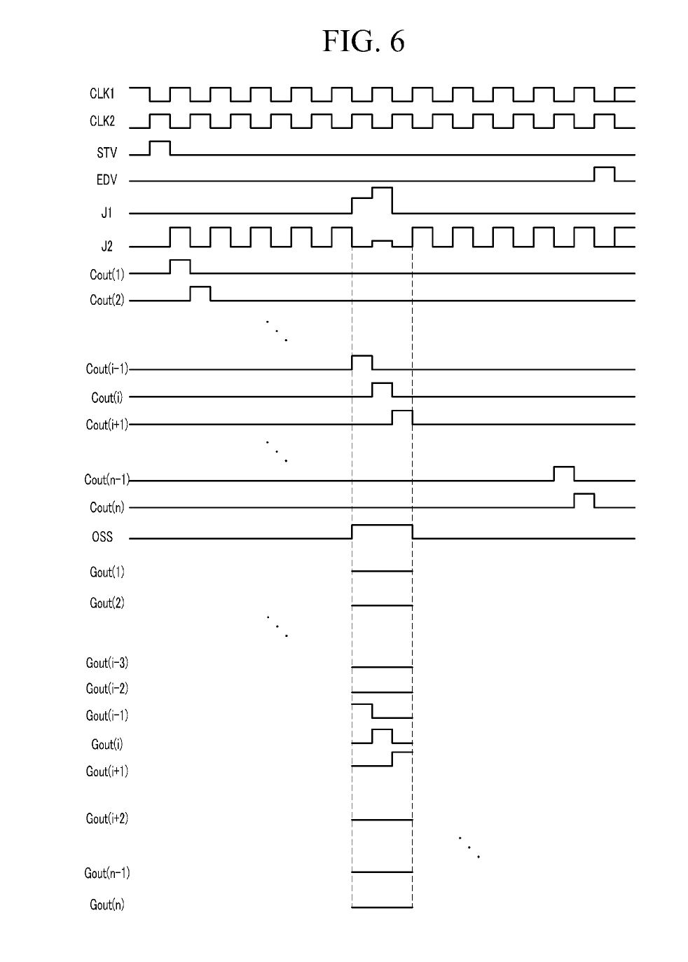

Hereinafter, the operation of the shift register shown in FIG. 5 will be described with reference to FIG. 6.

Before the operation of the shift register is described, it is noted that the previous stage [ST(i−1)] and the next stage [ST(i+1)] generate outputs in synchronization with a second clock signal CLK2 when an i^{th} stage [ST(i)] generates an output in consideration of a first clock signal CLK1. Also, a voltage level corresponding to a high voltage of the clock signals CLK1 and CLK2 is identical to a gate-on voltage Von and refers to a high voltage. A voltage level corresponding to a low level is identical to a gate-off voltage Voff and refers to a low voltage.

Initially, when the first clock signal CLK1 has the low voltage and the second clock signal CLK2 and a previous carry signal [Cout(i−1)] have the high voltage, transistors T2 and T6 are turned on. Then, a gate-on voltage Von is transferred to the junction J1 through transistor T2. As a result, transistors T1 and T7 are turned on. When a gate-off voltage Voff of the gate voltage terminal GV is transferred to the junction J2 through transistor T7, transistors T4 and T5 are turned off. At this moment, transistor T3 is sustained in a turned-off state because the next carry signal [Cout(i+1)] is the low voltage. Meanwhile, a gate-off voltage Voff is transferred to the junction J3 through the two turned-on transistors T1 and T6.

When a previous carry signal [Cout(i−1)] and the second clock signal CLK2 have a low voltage and the first clock signal CLK1 has a high voltage, transistors T2 and T6 are turned off and transistor T3 remains off because a next carry signal [Cout(i+1)] has a low voltage. When transistor T2 is turned off, the junction J1 is disconnected from the set terminal S, thereby becoming floated. Accordingly, transistors T1 and T7 remain on. At this moment, the gate-off voltage Voff is applied to the junction J2 through transistor T7. Accordingly, transistors T4 and T5 remain off.

Since transistors T5 and T6 are turned off, the gate-off voltage Voff of the gate voltage terminal GV transferred to the junction J3 is interrupted. Since transistor T1 remains on, only the gate-on voltage Von, which is the high voltage of the first clock signal CLK1, is transferred to the junction J3. Therefore, the junction J3 of the i^{th} stage [ST(i)] is identical to the gate-on voltage Von in synchronization with a rising edge of the first clock signal CLK1.

At this time, the capacitor C2 charges a voltage corresponding to the difference of the gate-on voltage Von and the gate-off voltage Voff. Since the capacitor C2 sustains a constant voltage, the voltage of the junction J3 rises to the gate-on voltage Von. As a result, the voltage of the floated junction J1 further rises as much as the gate-on voltage Von.

Due to a parasitic capacitance caused by the overlapping of the control terminal and the output terminal of the transistor T7, the voltage of junction J1 increases. Then, the potential of junction J2, which is the output terminal, also increases somewhat, as shown. The capacitor C1 charges a voltage corresponding to the difference of the gate-on voltage Von that is a high voltage of the first clock signal CLK1 and the gate-off voltage Voff that is the voltage of junction J2.

When the first clock signal CLK1 has a low voltage and the second clock signal CLK2 and the next carry signal [Cout(i+1)] have a high voltage, transistors T3 and T6 are turned on. Since the previous carry signal [Cout(i−1)] remains at the low voltage, transistor T2 remains off.

Since transistor T3 is turned on, the gate-off voltage Voff is transferred to the junction J1 and transistors T1 and T7 are turned off. When transistor T7 is turned off, junction J2 becomes floated, and since the capacitor C1 sustains a constant voltage at this moment, the first clock signal CLK1 has the low voltage. Accordingly, the voltage of the junction J2 further falls below the gate-off voltage Voff.

However, when the voltage of junction J2 falls below the gate-off voltage Voff, transistor T7 is turned on again and the gate-off voltage Voff is transferred to the junction J2. Therefore, the voltage of junction J2 is identical to the gate-off voltage Voff in a final parallel state. Accordingly, transistors T4 and T5 remain off.

Since transistor T1 is turned off and transistor T6 is turned on, the gate-off voltage Voff of the gate voltage terminal GV is transferred and output to junction J3, and the capacitor C2 is discharged.

After that, only the first and second clock signals CLK1 and CLK2 change to the low voltage and the high voltage, respectively. However, the voltage level variation of the first clock signal CLK1 lifts the voltage of junction J2 up to the gate-off voltage Voff, and the voltage level variation of the second clock signal CLK2 periodically turns transistor T6 on and off. Therefore, the gate-off voltage Voff is periodically applied to junction J3. Accordingly, junction remains at the gate-off voltage Voff.

After the next carry signal [Cout(i+1)] changes to the low voltage and transistor T3 is turned off, junction J3 of the i^{th} stage [ST(i)] remains at the low voltage, that is, the gate-off voltage Voff, regardless of the first and second clock signals CLK1 and CLK2.

That is, when the first clock signal CLK1 has the high voltage and the second clock signal CLK2 has the low voltage, the voltage of junction J2 rises due to the capacitor C1 to turn on transistors T4 and T5. Accordingly, the gate-off voltage Voff is transferred to junction J1 so transistors T1 and T7 remain off. Further, the gate-off voltage Voff is transferred to junction J3 through the turned-on transistor T5.

When the first clock signal CLK1 has the low voltage and the second clock signal CLK2 has the high voltage, the voltage of junction J2 falls due to the capacitor C1 to turn off transistors T4 and T5. Accordingly, junction J1 is floated. Therefore, junction J1 remains at the low voltage, which is the previous voltage, due to the capacitor C2 so transistors T1 and T7 remain off.

Also, transistor T6 is turned on, and the gate-off voltage Voff is transferred to junction J3. Although the first and second clock signals CLK1 and CLK2 change at predetermined periods later, junction J3 constantly remains at the gate-off voltage Voff.

When the selection signal OSS is the gate-on voltage Von at a high level, since transistor T8 is turned on, the voltage of junction J3, that is, the preliminary output signal, is transmitted to the output terminal OUT and is output as the image scanning output [Gout(i)]. To the contrary, when the output selection signal OSS is the gate-off voltage Voff t the low level, since transistor T8 is turned off, the signal is not output to the output terminal OUT. Accordingly, the gate line Gi is floated.

The carry output terminal COUT transmits the voltage of junction J3 to the reset terminal R of the previous stage [ST(i−1)] and the set terminal S of the next stage [ST(i+1)] regardless of the output selection signal (OSS).

Accordingly, as shown in FIG. 6, the carry signal [Cout 1-Cout(n)] becomes the gate-on voltage Von after applying the scanning start signal STV. However, the image scanning output [Gout 1-Gout(n)] may be output for the period that the output selection signal OSS is at the high level, particularly when the carry signal [Cout 1-Cout(n)] is the gate-on voltage Von in this period, for example, the image scanning output [Gout(i−1), Gout(i), Gout(i+1)] corresponding to the carry signals [Cout(i−1), Cout(i), Cout(i+1)] becomes the gate-on voltage Von in FIG. 6.

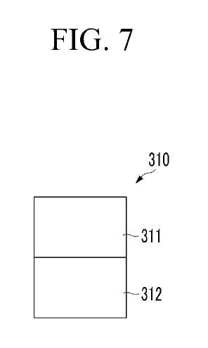

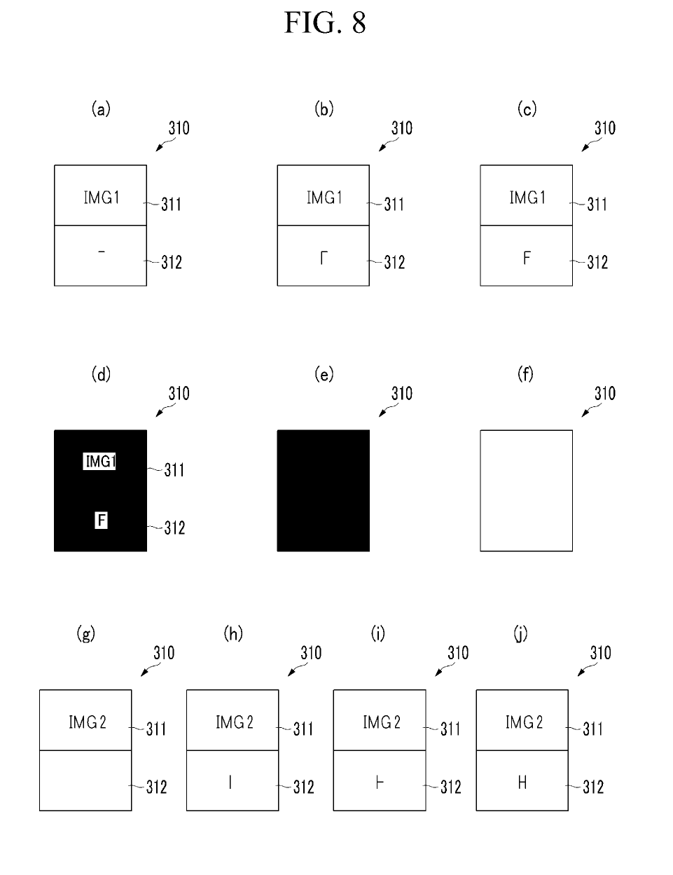

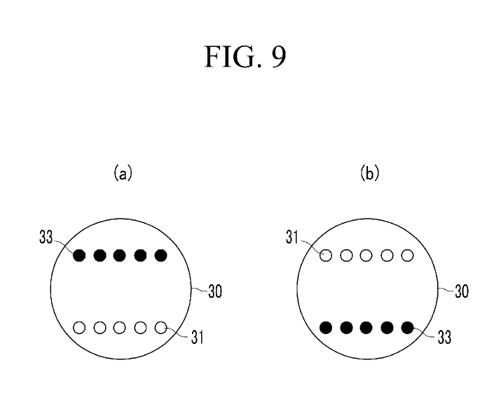

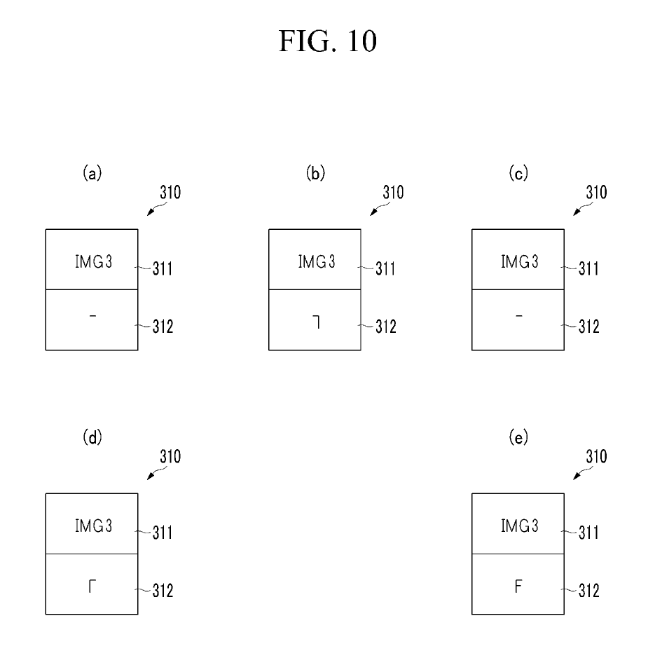

Next, an EPD that can write and erase characters on a portion of the screen according to an exemplary embodiment of the present invention will be described with the reference to FIG. 7, FIG. 8, FIG. 9, and FIG. 10.

In FIG. 7, a display area 310 to display an image in an electrophoretic display 300 is shown, and the display area 310 includes a fixing display area 311 to display the image with a fixed state during a predetermined time and a changing display area 312 to write characters, etc. The two display areas 311 and 312 may be exchanged.

Examples of sequentially writing the letters “F” and “H” are shown in (a), (b), (c), (d), (e), (f), (g), (h), (i), and (j) in FIG. 8.

A fixed image IMG1, such as the contents of an electronic book, is represented in the fixing display area 311, and when there is information desired by the user in the contents of the image, the information may be written in the changing display area 312. That is, the EPD according to the present exemplary embodiment includes a touch sensing function such that the desired information may be written using fingers or a pen. The information may include various symbols, such as characters and numbers, and an example of writing a character will be described in the present exemplary embodiment.

For example, when writing the letter “F”, one strike after another is written, as shown in (a), (b), and (c) of FIG. 8.

The information for each stroke is input to the memory 650 of the signal controller 600 through the sensing signal processor 800. In other words, the memory 650 stores the unit strokes, which are, for example, where the finger of a user writes the character, in a unit. For example, the letter “C” may be written in one stroke, and the information regarding this character is stored in the memory 650. Differently, the letters “F” and “H” may be written in three strokes. In the same manner, the numbers “1”, “2”, and “3” may be written in one stroke, and the number “4” may be written in two strokes.

Next, when the user wants to see the next screen, a predetermined button (not shown) may be operated, for example, the next screen may be displayed by operating a page up button or an arrow button. Before displaying the next screen, as shown in (d) of FIG. 8, the inversion image of the previous screen is displayed such that the degradation of the EPD due to the incline of the charges, where the direction of the electric field applied to the electrophoretic particles 31 and 33 is the same, may be prevented (hereafter this is referred to as “charge compensation”).

That is, as above described, when the voltage is not applied to the pixel electrode 191 and the common electrode 270, the electrophoretic particles 31 and 33 may remain in their positions such that the same image may be displayed while minimizing power consumption. However, the levels of the charges of the electrophoretic particle 31 and 33 may exceed the appropriate amount if the electrophoretic particles 31 and 33 remain in their positions for a long period of time. Accordingly, when the electrophoretic particles 31 and 33 are not regularly controlled, a desired screen may not be displayed. This may be prevented by compensating the charges.

Also, as shown in FIG. 8(e) and 8(f), the screen displays black and white to completely remove the incline of the charge. That is, as shown in FIG. 9(a) and 9(b), the positions of the black color electrophoretic particles 33 and the white color electrophoretic particles 31 are completely exchanged to compensate the charges.

On the other hand, the sequence of the images may be freely exchanged to compensate the charges differently from FIG. 8(d), 8(e), and 8(f). For example, the black and white screens are firstly displayed with the sequences of FIG. 8(e), 8(f), and 8(d), and then the inversion image of the previous image may be displayed. Also, the black and white screens may be displayed, and then the inversion image of the next image of FIG. 8(h), which is the inversion image of the previous image, may be previously displayed. Of course, the inversion image of the fixing image IMG2 is only displayed before writing the character in this case. The charges may be compensated by the same method after writing the character “H”.

Also, the whole portion except for the image displayed in FIG. 8(c) and the black corresponding to the character may be displayed with black color, and then the whole screen may be again displayed with the white color to compensate the charges. The white color may be displayed the same as the image displayed and the black color corresponding to the character, and then the whole screen may be displayed with the black color to compensate the charges. The examples for writing and erasing a character are shown in FIG. 10(a), 10(b), 10(c), 10(d), and 10(e).

For example, when writing the letter “F” in the changing area 312, three strokes may be sequentially written.

As shown in FIG. 10(b), when generating an error, the mistaken portion must be erased. The user may erase the mistaken portion by operating a predetermined button provided in the EPD such as a delete button or a cancel button, and the mistaken portion may be erased with a stroke unit the same as the stored stroke unit.

To operate the erase function, a reverse voltage to the input information is applied to the memory 650. That is, the information of the second stroke of the letter “F” is stored in the memory 650, and the signal controller 600 controls the data driver 500 to apply a contrary data voltage corresponding to the position of the second stroke in response to the erase order from the user.

That is, when the screen is white and the character is black, the process of erasing the character includes applying the reverse voltage to the electrophoretic particles 31 and 33.

Next, as shown in FIG. 10(d) and 10(e), the character is written and completed.

On the other hand, the process shown in FIG. 8 and FIG. 10 is performed in a portion of the screen, and it is operated by selecting the portion of the output of the image scan driver 400, as above described.

Also, while an example in which a black character is written on a white screen is described in the exemplary embodiment of the present invention, a contrary case in which a white character is written on a black screen is possible.

According to an exemplary embodiment of the present invention, information of a symbol, such as a character or a number, may be written and erased on a portion of the screen.

It will be apparent to those skilled in the art that various modifications and variations can be made in the present invention without departing from the spirit or scope of the invention. Thus, it is intended that the present invention cover the modifications and variations of the invention provided they come within the scope of the appended claims and their equivalents.

What is claimed is:

1. An apparatus for driving a display device including first signal lines and second signal lines connected to a plurality of pixels, third signal lines and fourth signal lines connected to a plurality of sensors, and a display area to display images, comprising:
a data driver to apply a data signal to the first signal line;
an image scan driver to apply an image scanning signal to the second signal line;
a sensing scan driver to apply a sensing scanning signal to the third signal line;
a sensing signal processor connected to the fourth signal line;
a signal controller to control the data driver, the image scan driver, the sensing scan driver, and the sensing signal processor; and
a memory to store information from the sensing signal processor,
wherein the information is displayed and erased on a portion of the display area.

2. The apparatus of claim 1, wherein
an image is displayed on the display area except the portion of the display area displaying and erasing the information.

3. The apparatus of claim 2, wherein when changing a previous image into a next image in the display area, an inversion image of the previous image, a black image displaying a black color on the whole screen, and a white image displaying a white color on the whole screen are displayed in any order.

4. The apparatus of claim 2, wherein when changing a previous image into a next image in the display area, a black image, a white image, and an inversion image of the previous image are displayed in any order.

5. The apparatus of claim 2, wherein a black color is displayed on the screen except in black areas of a previous image when changing the previous image into a next image in the display area, and then a white color is displayed on the whole screen.

6. The apparatus of claim 2, wherein a white color is displayed in a portion corresponding to a black color of the previous image when changing the previous image into a next image in the display area, and then the black color is displayed on the whole screen.

7. The apparatus of claim 2, wherein the memory is included in the signal controller.

8. The apparatus of claim 2, wherein the information comprises a symbol of a character or a number, the symbol has at least one stroke, and the memory stores the symbol by a stroke unit.

9. The apparatus of claim 8, wherein the symbol is erased by a stroke unit.

10. The apparatus of claim 9, wherein the signal controller applies a reverse voltage to the voltage corresponding to the symbol when erasing the symbol.

11. The apparatus of claim 1, wherein the image scan driver comprises a plurality of stages disposed in a row and connected to the second signal line, and the output of the stages is applied to the second signal line disposed in the portion of the display area.

12. The apparatus of claim 11, wherein each stage comprises a set terminal, a reset terminal, a gate voltage terminal, a first clock terminal, a second clock terminal, a gate output terminal, and an output selection terminal.

13. The apparatus of claim 12, wherein each stage further comprises a first input section, a second input section, a preliminary output signal generator, and an output determiner, and
wherein the first input section comprises a first transistor having a control terminal and an input terminal commonly connected to the set terminal, and an output terminal connected to a first junction;
wherein the second input section comprises:
a second transistor having a control terminal connected to a reset terminal R, an input terminal to receive a gate-off voltage Voff, and an output terminal connected to the first junction,
a third transistor having a control terminal connected to a second junction, an input terminal to receive the gate-off voltage, and an output terminal connected to the first junction,
a fourth transistor having a control terminal connected to the first junction, an input terminal to receive the gate-off voltage, and an output terminal connected to the second junction, and
a first capacitor connected between the first clock terminal and the second junction,
wherein the preliminarily output signal generator comprises:
a fifth transistor having a control terminal connected to the first junction, an input terminal connected to the first clock terminal CK1, and an output terminal connected to a third junction,
a sixth transistor having a control terminal connected to the second junction, an input terminal to receive the gate-off voltage, and an output terminal connected to the third junction,
a seventh transistor having a control terminal connected to the second clock terminal, an input terminal to receive the gate-off voltage, and an output terminal connected to the third junction, and
a second capacitor connected to the first junction and the third junction and
wherein the output determiner comprises an eighth transistor having a control terminal connected to the output selection terminal, an input terminal connected to the third junction, and an output terminal connected to the gate output terminal.

14. The apparatus of claim 13, wherein each stage is directly integrated on the display.

15. The apparatus of claim 1, wherein the image scan driver comprises a plurality of driver ICs.

16. The apparatus of claim 15, wherein the driver ICs output to the second signal line disposed on the portion of the display area.

17. An electrophoretic display, comprising:
an electrophoretic display panel assembly;
first signal lines and second signal lines connected to a plurality of pixels;
third signal lines and fourth signal lines connected to a plurality of sensors;
a data driver to apply a data signal to the first signal line;
an image scan driver to apply an image scanning signal to the second signal line;
a sensing scan driver to apply a sensing scanning signal to the third signal line;
a sensing signal processor connected to the fourth signal line; and
a display area to display images,
wherein the information from the sensing signal processor is displayed and erased on a portion of the display area.

18. The electrophoretic display of claim 17, wherein an image is regularly displayed on the remainder of the display area.

19. The electrophoretic display of claim 18, wherein when changing a previous image into a next image in the display area, an inversion image of the previous image, a black image displaying a black color in the whole screen, and a white image displaying a white color on the whole screen are displayed in any order.

20. The electrophoretic display of claim 18, wherein a black color is displayed on the screen except in black areas of a previous image when changing the previous image into a next image in the display area, and then a white color is displayed on the whole screen.

21. The electrophoretic display of claim 18, further comprising:
a signal controller to control the data driver, the image scan driver, the sensing scan driver, and the sensing signal processor, and
wherein the signal controller comprises a memory to store the information from the sensing signal processor.

22. The electrophoretic display of claim 21, wherein the information comprises a symbol of a character or a number, the symbol has at least one stroke, and the memory stores the information of the symbol by a stroke unit.

23. The electrophoretic display of claim 22, wherein the symbol is erased by a stroke unit.

24. The electrophoretic display of claim 23, wherein the signal controller applies a reverse voltage to the voltage corresponding to the symbol when erasing the symbol.
